(19) United States
(12) Patent Application Publication
(10) Pub. No.: US 2003/0059076 A1
(43) Pub. Date: Mar. 27, 2003

(54) Hearing aid device with automatic switching to hearing coil mode

(76) Inventor: Raimund Martin, Eggolsheim (DE)

Correspondence Address: SCHIFF HARDIN & WAITE, 6600 SEARS TOWER, 233 S WACKER DR, CHICAGO, IL, 60606-6473, US

(21) Appl. No.: 10/253,727

(22) Filed: Sep. 24, 2002

(30) Foreign Application Priority Data
Sep. 24, 2001 (DE) 101 46 886.5

(51) Int. Cl. H04R 25/00

(52) U.S. Cl. 381/331

(57) ABSTRACT

A beneficial automatic switching and control of hearing aid devices is based on a respective auditory situation. An acoustic signal and an induction signal are picked up for controlling the hearing aid device. Subsequently, the acoustic signal is evaluated and compared to the induction signal in view of prescribed parameters such as level, carrier frequency, modulation frequency, degree of modulation and/or estimated signal-to-noise ratio. Finally, the hearing aid device is controlled on the basis of the comparison in view of the input signal, individual hearing aid parameters or entire hearing programs.

### BACKGROUND OF THE INVENTION

1. Field of the Invention

The present invention is directed to a hearing aid device having an acoustic pick-up for picking up an acoustic signal, an induction pick-up for picking up an induction signal and a control device for controlling the hearing aid device. Additionally, the present invention is directed to a method for controlling a hearing aid device.

2. Description of the Related Art

Hearing aids are utilized in a variety of auditory situations and must communicate desired acoustic stimuli to the patient. In, for example, street traffic, the user wants an omnidirectional sound perception for perceiving danger and would like to experience a directed sound perception in a conversation with a conversation partner. Also, low-noise telephoning should be possible for the hearing aid user both with cord-bound as well as with cordless telephones as well as with mobile radiotelephones.

Hearing aids can usually adapt to different auditory situations in that the hearing aid user can switch the aids into different hearing programs. A typical hearing program is the telephone hearing program in which the acoustic signals that the microphone of the hearing aid picks up are filtered according to the spectrum of telephone signals in order to suppress unwanted ambient noises in other spectral ranges. High-quality hearing aid devices usually have a plurality of microphones that can be interconnected by a specific hearing program in order to achieve a directional effect.

In addition to one or more microphones, induction pick-ups are often provided in hearing aids that enable a hearing coil mode. This assures that acoustic signals from a telephone device that has a hearing coil are inductively transmitted onto the hearing aid device. As known, such a hearing coil mode has the advantage that unwanted sound from the surroundings are not transmitted via the hearing aid when telephoning.

The switching or control of hearing aids usually ensues with switches, keys, or controls at the housing of the hearing aid device. Given “behind-the-ear” hearing aid devices (BTE), this represents no problem since they have a corresponding structural size. However, with “in-the-ear” hearing aid devices (ITE), which are located in the external ear or even exclusively in the auditory canal (complete in the channel (CIC) devices), it is difficult to apply manual switches, keys, or controls to the hearing aid itself because their structural size is so small. The ITE hearing aid devices are therefore usually automatically controlled and switched.

As known, a hearing aid device can be automatically switched into a telephone hearing program when a magnetic field that is emitted by the earphone of a telephone device is detected. In this field, German patent document DE 31 09 049 C2 states that the application of a magnetic field is also required for the actuation of the switching event due to the use of elements that change their electrical properties, for instance the conductivity, in the sense of a switch under the influence of a magnetic field. For instance, a displaceable magnet can be utilized as switch element. The actual contact elements are included in the category of non-contacting switches and can, for example, be fashioned as “reed contacts” or as magnetic field semiconductors that are also Hall generators. For the switch event, it is thus necessary that the hearing aid device register a static magnetic field so that it amplifies the inductively received signals according to the telephone hearing program.

Difficulties regularly occur in the automatic switching into a telephone hearing program when, for example in lecture halls, the signal is in fact inductively transmitted by loops in the floor but a magnetic equisignal is not present. The same problem occurs given mobile and cordless telephones that comprise piezoelectric earphones. Problems likewise occur in manual switching when the hearing aid user switches into the hearing coil mode in the accustomed way when telephoning with a mobile telephone but the mobile telephone is not designed for the inductive transmission of auditory signals.

### SUMMARY OF THE INVENTION

The object of the present invention is to provide an automatic switching and control of hearing aids in view of the respective auditory situation that addresses the above-mentioned problems.

This object is inventively achieved by a hearing aid device having an acoustic pick-up for picking up an acoustic signal, an induction pick-up for picking up an induction signal and a control device for controlling the hearing aid device, as well as a comparison device for comparing the picked-up acoustic signal to the picked-up induction signal and supplying a comparison result to the control device for controlling the hearing aid device on the basis of the comparison result.

Additionally, the object of the invention is achieved by a method for controlling a hearing aid device by picking up an acoustic signal and an induction signal, comparing the acoustic signal to the induction signal and controlling the hearing aid on the basis of the comparison.

Inventive developments of the invention include having the induction pick-up comprise an auditory coil for picking up an audio coil signal that corresponds to at least one of an electrically and magnetically converted acoustic signal. Also, the comparison device may be configured so that at least one of an acoustic signal and an audio coil signal can be analyzed by the comparison device in terms of at least one of level, carrier frequency, modulation frequency, degree of modulation and estimated signal-to-noise ratio. The acoustic pick-up may comprise one or more microphones. The comparison device may comprise at least one of a Bayes' classifier, a neural network, and a fuzzy controller for the evaluation of at least one of an acoustic and an audio coil signal. The control device may be configured to select at least one of the acoustic pick-up and the induction pick-up as a hearing aid input. The comparison device may also be configured to constantly supply comparison results.

Inventive developments of the method include having the induction signal comprise an audio coil signal that corresponds to at least one of an electrically and magnetically converted acoustic signal. The method may also include evaluating the induction signal and acoustic signal in terms of at least one of level, carrier frequency, modulation frequency, degree of modulation and estimated signal-to-noise ratio in the comparison. The method may include evaluating at least one of the acoustic signal and induction signal with at least one of a Bayes' classifier, a neural network, and a fuzzy controller in the comparison. The inventive method may further comprise selecting, by a control device of the hearing aid, at least one of the acoustic signal and the induction signal as an input signal for the hearing aid device. The method may comprise at least partially selecting the acoustic signal as an input signal of the hearing aid based on the comparison result. The method may further comprise selecting the acoustic signal of the hearing aid device when its intensity is higher than that of the induction signal. Finally, the method may include processing the acoustic signal and the induction signal in a time-division multiplex manner in a same signal processing block.

These inventive developments are described more fully below.

As a result of the inventive comparison of the induction signal from the induction pick-up and the microphone signal from the acoustic pick-up, an automatic decision can be made on the basis of prescribed decision criteria as to whether the hearing aid device is to be switched into a hearing coil mode or a microphone mode. The hearing aid device thereby automatically optimizes the sound reception for the hearing aid user.

### DESCRIPTION OF THE DRAWINGS

The present invention is explained below in greater detail on the basis of the attached drawings.

FIG. 1 is a schematic block diagram showing the schematic structure of a hearing aid device; and

FIG. 2 is a flowchart showing the fundamental sequence of the inventive method.

### DETAILED DESCRIPTION OF THE INVENTION

The exemplary embodiments described below represent preferred embodiments of the invention.

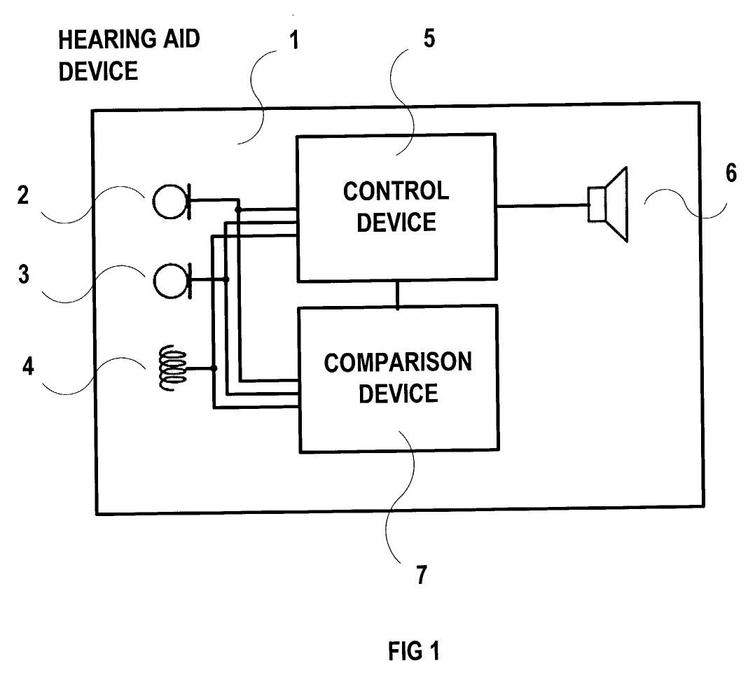

According to FIG. 1, a digital hearing aid device 1 comprises two microphones 2, 3 and—optionally—an auditory coil 4. The two microphones 2, 3 pick up the corresponding sound and convert it for the control device 5 for further processing. The signal emitted by the induction system or a telephone coil is inductively picked up in the auditory coil or the induction pick-up 4 and is likewise forwarded to the control device 5 for further processing. The control device 5 analyzes the signals obtained from the pick-ups 2, 3 and 4 and controls or switches the transfer function between the pick-ups 2, 3, 4 and a loudspeaker 6.

Inventively, it is not the signal of a switch or a constant signal of an external device such as, for example, the static magnetic field signal of a telephone earphone coil that is employed for switching or controlling the hearing aid device or its hearing programs and/or transmission parameters. According to the present invention, on the contrary, the signals of the induction pick-up are utilized for the switching or control parallel to the signals of the microphones.

The invention provides that the signal picked up by the induction coil 4 is constantly monitored and analyzed in addition to the one or more microphone signals. The invention makes a continual investigation with a comparison device 7 as to whether the induction signal is a payload signal, for example voice with a good signal-to-noise ratio. This task, for example, can be assumed by a classification algorithm.

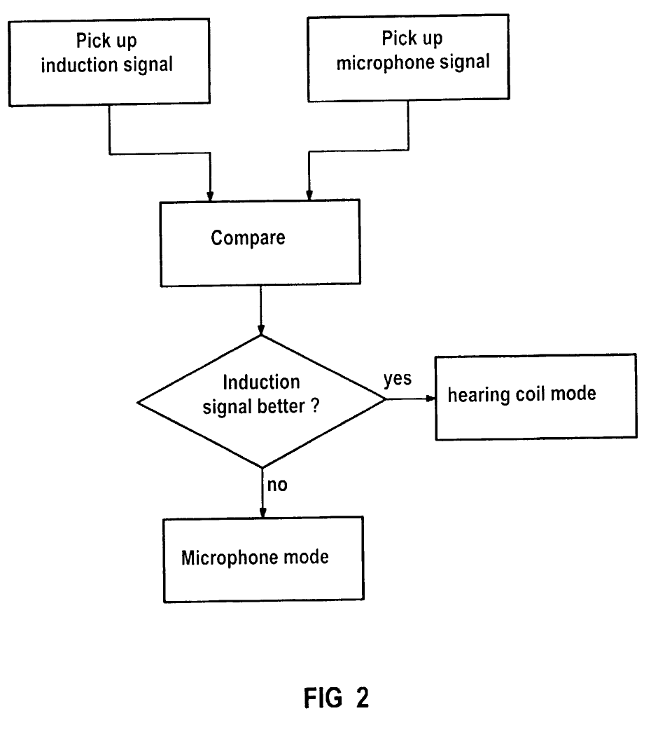

Given a digital hearing aid with a plurality of signal inputs (microphones 2, 3 and auditory coil 4), the acoustic signals picked up by the microphones 2, 3 and the inductive signal picked up by the auditory coil 4 are simultaneously digitalized and analyzed. The classification algorithm constantly analyzes all input signals in view of their characteristic quantities such as level, frequency, modulation frequency, degree of modulation and/or estimated signal-to-noise ratio, etc. A decision regarding which of the input signals is to be preferred is made on the basis of these characteristic quantities using a specific method, for example by using Bayes' classifier, neural network, fuzzy controller, etc. The corresponding input signal is automatically selected for the further-processing. According to FIG. 2, accordingly, a switch to the auditory coil mode is made when the induction signal is better than the microphone signal. Otherwise, the hearing aid device automatically switches into microphone mode.

As needed, a possibility for manual intervention with known switches, keys, etc. can also be provided for the hearing aid user. This could be advantageous, for example, when the hearing aid user wants to receive the induction signal in a lecture hall and persons in the immediate proximity are talking relatively loudly, so that the hearing aid device would automatically switch into the microphone mode under certain circumstances. The manual intervention would permit the automatic selection to be overridden.

The parallel analysis of the induction signal and of the microphone signal is comparatively involved. For minimizing the outlay, the analysis of the induction signal can, for example, ensue in a time-division multiplex method with signal processing blocks that are also employed for the microphone signal.

The hearing aid device can be switched or controlled based on the comparison result following the analysis. In the framework of the respective switch or control event, thus, the source of the input signal can be automatically selected as a hearing aid parameter. Furthermore, the hearing aid device can be switched into an auditory coil mode and a hearing program connected with it when the induction signal is better than the signal of the microphone or microphones. The filter bandwidth of the hearing aid device can likewise be reduced when the hearing aid device registers telephoning where an induction signal is in fact present but the microphone signal is better.

In addition to the control of individual parameters, this means that a plurality of parameters that are combined in “hearing programs” can be simultaneously modified in that a switch is made from one hearing program into another. In a lecture hall, for example, a switch can thus be made from a hearing program for omnidirectional hearing into a hearing program for directional hearing when no induction signal is present.

Since the input signals of the induction coil and of the microphone or microphones 2, 3 are constantly picked up and analyzed, an inventive development of the inventive hearing aid device can provide that both input signals are mixed for the transmission in the hearing aid device. It is definitely advantageous for the hearing aid user to also be able to perceive ambient noise to a certain extent when using the auditory coil mode in a lecture hall. This is necessary when someone neighboring the hearing aid user wishes to converse softly with the hearing aid user. In other words, the control of the hearing aid can also ensue such that switching into an auditory coil mode or microphone mode is not purely alternative; rather, a switch can also be made to a mixed mode in which the respective levels are correspondingly selected.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### LIST OF REFERENCE CHARACTERS

1 hearing aid device

2 microphone

3 microphone

4 hearing coil/induction pick-up

5 control device

6 loudspeaker

7 comparison device

What is claimed is:

1. A hearing aid device, comprising:
an acoustic pick-up for picking up an acoustic signal;
an induction pick-up for picking up an induction signal;
a control device for controlling the hearing aid device;
a comparison device configured for comparing a picked-up acoustic signal to a picked-up induction signal and supplying a comparison result to the control device for controlling the hearing aid device on the basis of the comparison result.

2. The hearing aid device according to claim 1, wherein the induction pick-up comprises an auditory coil for picking up an audio coil signal that corresponds to at least one of an electrically and magnetically converted acoustic signal.

3. The hearing aid device according to claim 1, wherein the comparison device is configured so that at least one of an acoustic signal and an audio coil signal can be analyzed by the comparison device in terms of at least one of level, carrier frequency, modulation frequency, degree of modulation and estimated signal-to-noise ratio.

4. The hearing aid device according to claim 1, wherein the acoustic pick-up comprises one or more microphones.

5. The hearing aid device according to claim 1, wherein the comparison device comprises at least one of a Bayes' classifier, a neural network, and a fuzzy controller for the evaluation of at least one of an acoustic and an audio coil signal.

6. The hearing aid device according to claim 1, wherein the control device is configured to select at least one of the acoustic pick-up and the induction pick-up as a hearing aid input.

7. The hearing aid device according to claim 1, wherein the comparison device is configured to constantly supply comparison results.

8. A method for controlling a hearing aid device, comprising:
picking up an acoustic signal by the hearing aid device;
picking up an induction signal by the hearing aid device;
comparing the acoustic signal to the induction signal thereby producing a comparison result; and
controlling the hearing aid device based on the comparison result.

9. The method according to claim 8, wherein the induction signal comprises an audio coil signal that corresponds to at least one of an electrically and magnetically converted acoustic signal.

10. The method according to claim 8, further comprising:
evaluating the induction signal and acoustic signal in terms of at least one of level, carrier frequency, modulation frequency, degree of modulation and estimated signal-to-noise ratio in the comparison.

11. The method according to claim 8, further comprising:
evaluating at least one of the acoustic signal and induction signal with at least one of a Bayes' classifier, a neural network, and a fuzzy controller in the comparison.

12. The method according to claim 8, further comprising:
selecting, by a control device of the hearing aid, at least one of the acoustic signal and the induction signal as an input signal for the hearing aid device.

13. The method according to claim 8, further comprising:
at least partially selecting the acoustic signal as an input signal of the hearing aid based on the comparison result.

14. The method according to claim 8, further comprising:
selecting the acoustic signal of the hearing aid device when its intensity is higher than that of the induction signal.

15. The method according to claim 8, further comprising:
processing the acoustic signal and the induction signal in a time-division multiplex manner in a same signal processing block.
